(19) United States
(12) Patent Application Publication
(10) Pub. No.: US 2006/0262266 A1
(43) Pub. Date: Nov. 23, 2006

(54) Method of producing an electronic device, electronic device and apparatus for implementing the method

(76) Inventors: Joost P. A. Vogels, Leende (NL); Paulus C. Duineveld, Eindhoven (NL); Stephen I. Klink, Breda (NL); Roel Penterman, Eindhoven (NL); Dirk J. Broer, Geldrop (NL); Hjalmar E. A. Huitema, Veldhoven (NL); Jan B. P. H. Van Der Putten, Helmond (NL); Marc J. R. Op De Beeck, Dessel (BE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/569,312

(22) PCT Filed: Jun. 25, 2004
(86) PCT No.: PCT/IB04/02137

§ 371 Date: Feb. 21, 2006

(30) Foreign Application Priority Data
Aug. 23, 2003 (GB) 0319908.0

(51) Int. Cl. G02F 1/1339

(52) U.S. Cl. 349/156

(57) ABSTRACT

The electronic device (1) of the present invention has a carrier (10) with a plurality of discrete electro-optical elements (110, 130, 150) mounted on the surface of the carrier (10). The electro-optical elements (110, 130, 150), which cover respective parts of the electrode structure (12) on the surface of the carrier (10), each have a polymer layer (114, 134, 154), which encloses an electro-optical material (102, 122, 142) between the polymer layer (114, 134, 154) and the surface of the carrier (10). The discrete electro-optical elements (110, 130, 150) have been formed by the individual deposition of discrete droplets of a liquid comprising the electro-optical material and a polymer precursor followed by exposure of the droplets to a stimulus triggering the polymerization of the polymer precursor.

The present invention relates to a method of producing an electronic device comprising a plurality of electro-optical elements on a surface of a carrier, the carrier surface including an electrode structure.

The present invention also relates to an electronic device comprising a carrier having a carrier surface including an electrode structure and a plurality of electro-optical elements mounted on the carrier surface.

Several electronic devices utilize electro-optical elements to implement a targeted function of the device. Such electro-optical elements can be based on the principle that the application of an electrical field or a current will alter the orientation or configuration of the electro-optical material, which has an impact on the interaction of the material with light. For instance, the electrical field induces a change in orientation or configuration of the electro optical material that may allow light to pass the electro-optical element, and electro-optical elements being based on such a principle are therefore also referred to as light-valve elements.

The class of electronic devices including electro-optical elements include electrophoretic displays like e-ink devices and liquid crystal displays (LCDs), with the latter having become increasingly popular over recent years. LCDs can be found in a wide range of products, from handheld electronic devices like personal digital assistants and mobile phones to computer monitors and television sets.

Currently, much effort is being put in upscaling the dimensions of these electronic devices, e.g. LCDs. However, traditional production methods of LCDs, in which a liquid crystal material is deposited between two glass or polymer plates, are not ideal for such efforts, because increasing the size of the substrate panes makes them difficult to handle. In addition, large substrate panes require large and heavy machinery, which makes the production process costly.

European patent application EP 1065553 A1 discloses an alternative method for producing a liquid crystal display. A layer of a mixture of a polymer precursor and a liquid crystal (LC) material is deposited on a transparent substrate carrying an orientation layer, after which the mixture is exposed to UV light in a photolithographic step. In this step, the polymer precursor is polymerized to form sidewalls between the desired pixels of the LCD. Subsequently, the rest of the mixture is exposed to UV light. This triggers a phase separation in which the polymer precursor is polymerized to form a continuous top layer on top of the polymer sidewalls, and in which the LC material is trapped between the polymer top layer, the polymer sidewalls and the substrate, thus forming a plurality of pixels on the substrate, with the polymer top layer serving as a second substrate.

However, it is a serious drawback of this method that several photolithography steps are still required to form the separate LC pixels, for instance because the development and production of masks is costly.

Inter alia, it is an object of the present invention to at least reduce the number of required photolithographic steps in the production of an electronic device according to the opening paragraph.

It is another object to provide an improved electronic device according to the opening paragraph.

It is yet another object of the present invention to provide an apparatus for implementing the method of the present invention.

According to an aspect of the present invention, there is provided a method of producing an electronic device comprising a plurality of electro-optical elements on a surface of a carrier, the method comprising the steps of depositing a plurality of discrete droplets of a first liquid on the carrier surface, the first liquid comprising a mixture of a first electro-optical material and a first polymer precursor; and forming the plurality of electro-optical elements by exposing the plurality of discrete droplets to a stimulus for polymerizing the polymer precursor of a discrete droplet of the first liquid into a discrete polymer layer enclosing the first electro-optical material of the discrete droplet between said polymer layer and the carrier surface. This method will also be referred to as the first method of the present invention.

By depositing discrete droplets of a mixture of an electro-optical material such as a liquid crystal material and a polymer precursor over the electrode structure on the carrier surface, the discrete electro-optical elements, e.g., pixels, are predefined by the droplets. Such an electro-optical element may be formed by a single droplet or, if desired, formed by merging a plurality of droplets together by depositing them on the same location, i.e., on top of each other, on the carrier surface. This has the advantage that no photolithography step is required to acquire separate electro-optical elements. The droplets can simply be deposited by means of known printing techniques such as piezo-electric or continuous inkjet printing or bubble jet printing. Depending on the polymer precursor, the polymerization reaction can be initiated over the whole carrier surface by applying an appropriate stimulus like UV light exposure, heat, electron beam exposure and other known suitable polymerization initiators. Consequently, the production method of the present invention is cheaper and more versatile than the prior art production methods.

An additional advantage is that the electronic device size to be produced on a single carrier can be increased without causing an excessive increase in production cost, due to the fact that photolithographic masks are not necessarily required in the production process of the electronic device of the present invention. Also, there is no technical limitation to the number of electronic devices that may be produced on a single carrier, which improves efficiency of the production process, thus further reducing production cost.

The carrier surface may be modified by depositing an electrode structure such as an interdigitated electrode structure for controlling the liquid crystal elements with in-plane switching effects. In case of the electro-optical material being an LC material, the carrier surface may be modified by depositing an orientation layer such as a rubbed polyimide alignment layer or a photo-aligning material like a cinnamate or a coumarin containing polymer prior to the deposition of the droplets, in order to ensure that the LC material adopts the required orientation in the electro-optical element. In addition, the carrier surface may be extended with other optical layers such as polarization filters, retardation layers, color filters and so on. The LC material may be chosen to, for instance, implement electrically controlled birefringence (ECB), twisted nematic (TN), super twisted nematic (STN), optically compensated birefringence (OCB), vertically aligned nematic (VAN), ferroelectric (FE) or in-plane switching (IPS) LC effects in combination with appropriate electrode structures and alignment layers.

An additional advantage of the production method of the present invention is that the shape of the arrangement of the plurality of electro-optical elements is no longer governed by the shape of the carrier surface. By depositing the electro-optical material at the pixel level, the electro-optical elements can be deposited on a predefined part of the carrier surface, thus forming predefined shapes like images. This is particularly advantageous for electronic devices being arranged to display fixed images.

In an embodiment, the step of depositing the plurality of discrete droplets is preceded by the step of depositing a pattern of wall structures on the carrier surface for creating a plurality of bordered domains on the carrier surface, a droplet from the plurality of discrete droplets being deposited in such a bordered domain. The deposition of a plurality of wall structures has the advantage that the wall structures prevent the individual droplets from further spreading, which prevents droplets from becoming too thin or from merging with a neighbouring droplet. Consequently, electro-optical elements having a near flat surface can be obtained.

Alternatively, the step of depositing a plurality of discrete droplets is preceded by the step of depositing a plurality of regions of a non-wetting material on the carrier surface. The non-wetting regions may be used for creating a plurality bordered domains on the carrier surface, a droplet from the plurality of discrete droplets being deposited in such a bordered domain. The contact angle of the droplets with this non-wetting layer is substantially larger than the contact angle of the droplets with the carrier substrate. Consequently, the non-wetting regions prevent the excessive spreading of droplets and neighbouring droplets from merging.

In a more specific embodiment, before depositing the plurality of discrete droplets, the substrate carrier surface is provided with a plurality of first regions functionalized for selective accumulation of polymer material and a plurality of second regions functionalized for selective accumulation of the electro-optical material (102), respective first regions being provided between respective second regions and respective regions (302) of a non-wetting material. The first and second region of selective accumulation facilitate the phase separation into the polymer layer and the electro-optical material in the desired manner. Further, because adhesion between the polymer layer and the carrier surface is generally improved a mechanically more robust structure is obtained. The first region may be provided by depositing a separate layer which partially overlaps or is adjacent (abutting or spaced) with a layer providing the non-wetting regions. The selectivity of the first and second regions is relative in that there is a differential selectivity in accumulation, for example electro-optical material may selectively accumulate in the second region because the polymer material selectively accumulates in the first.

In one embodiment of the method in accordance with the invention the first liquid comprises a first colorant which, during formation of the plurality of electro-optical elements, selectively accumulates in the polymer layer. The colorant may be a dye or a pigment, or a mixture of dyes and/or pigments and preferably has a color in the visible part of the electromagnetic spectrum. Selective accumulation may for example be achieved by choosing a colorant which has a higher solubility in the polymer layer than in the liquid layer. Selective accumulation is conveniently realized using a colorant which is functionalized with reactive groups adapted to react with the first polymer precursor during formation of the plurality of electro-optical elements. During formation the colorant reacts with the polymeric material being formed and because the polymeric material phase separates into a discrete polymer layer the first colorant is incorporated in the discrete polymer layer. More specifically, the first colorant is (co-)polymerizable to form a polymer of the discrete polymer layer. In other words, the first colorant is a monomer of the polymer precursor.

Adding colorant to the mixture reduces the number of steps of the process to manufacture a device which requires such a dye, such as a (full) color LCD device. The process of depositing the colorant is also self-aligned with the deposition of the liquid.

In another embodiment, the method further comprises the steps of depositing a plurality of discrete droplets of a second liquid on the carrier surface, the second liquid comprising a mixture of a second electro-optical material and a second polymer precursor; and forming a further plurality of electro-optical elements by exposing the plurality of discrete droplets of the second liquid to a second stimulus for polymerizing the second polymer precursor into a further discrete polymer layer enclosing the second electro-optical material between said further polymer layer and the carrier surface. These steps are preferably executed substantially in parallel to improve production efficiency. Even though the first electro-optical material and the second electro-optical material may be the same material, the fact that the method of the present invention deposits each electro-optical element individually can be used to deposit different types of electro-optical material at a single carrier surface. For instance, a first liquid crystal material and a second liquid crystal material can be chosen to define different electro-optical elements, e.g., different colour pixels. Differently colored discrete elements can be achieved using a first colorant in the first and a second colorant having a color different from the first. This way, the intended performance of the electro-optical elements can be improved by depositing the appropriate electro-optical materials. It will be obvious to those skilled in the art that this approach can be extended to any number of different liquids, e.g., three different liquids for a RGB colour display device, and so on. For example, an RGB full colour display device may be conveniently realized using in respective first, second and third elements, respective red, green and blue colorants which selectively accumulate in the respective polymer layers of the first, second and third elements. Thus the number of steps required to make such a device are reduced and the process of providing the colorants is self-aligned with the liquid.

After the formation of the electro-optical elements, the electronic device may be further processed. For instance, the method of the present invention may further comprise the step of depositing a further electrode structure on a polymer layer of the plurality of electro-optical elements to produce an electronic device having electro-optical elements sandwiched between a bottom electrode structure and a top electrode structure or to produce an electronic device having a single electrode structure opposite the carrier surface.

In addition, the method may further comprise the steps of covering the plurality of electro-optical elements with a light reflecting coating in the case of reflective TN, STN, ECB and IPS LC material to provide for a light-reflective electronic device and/or covering the plurality of electro-optical elements with a planarization layer to facilitate further processing steps on the electronic device. Also, a step of adding a light-polarizing layer to the carrier may be executed prior to or after depositing the electro-optical elements. This is particularly useful in the case of the electronic device being a reflective or transmissive display having a transparent carrier.

According to a further aspect of the invention, there is provided a method of producing an electronic device comprising a display area on a part of a surface of a carrier carrying an electrode structure, the method comprising the steps of dripping a first liquid on the part of the carrier surface, the first liquid comprising a mixture of a first electro-optical material and a first polymer precursor; and forming the display area by exposing the first liquid to a stimulus for polymerizing the polymer precursor into a discrete polymer layer enclosing the first electro-optical material between said polymer layer and the carrier surface. This method will also be referred to as the second method of the present invention.

Rather than depositing droplets with the intention to keep them separated to obtain discrete electro-optical elements, the printing technique of the present invention can also be advantageously applied to produce electronic devices having a single or a few display areas, e.g., display devices having a predefined single image, such as a billboard. By dripping the first liquid on a part of the carrier surface, a better-defined display area can be formed than was the case with prior art deposition techniques such as doctor blading, because spillage of the first liquid outside the part of the carrier surface was difficult to avoid with these techniques.

It will be recognized by those skilled in the art that the second method of the present invention is a special instance of the first method of the present invention, because in fact a display device with a single electro-optical element rather than a plurality of electro-optical elements is being formed. Advantageously, the method comprises the step of bordering the part of the carrier surface with a dewetting material prior to the dripping of the first liquid on the predefined part. This can yield an even better defined display area.

In an embodiment, the method comprises the step of providing a further surface of the carrier with an adhesive layer. Electronic devices that are formed via the first or second method of the present invention can be very light-weight, because the use of heavy carriers can be avoided. This for instance allows for such electronic devices to be used as sticker displays. This is particularly advantageous for electronic devices formed by the second method of the present invention, because such devices require very little driver circuitry, e.g., an on/off signal generator, which can easily be integrated onto or into the carrier.

Advantageously, the method further comprises the step of integrating a power supply into the carrier. This yields an electronic device that can be used in many places because the presence of an external power supply is not required for the operation of the electronic device.

Alternatively, the method further comprises the step of providing the further surface with a conductive contact, the conductive contact being conductively coupled to the electrode structure. This allows for the electronic device to be formed to be used for a prolongued period of time, because an external, replenishable power supply can be used.

According to yet another aspect of the invention, there is provided an electronic device comprising a carrier having a surface and a plurality of electro-optical elements positioned on the carrier surface, each of the electro-optical elements having a discrete first polymer layer enclosing a first electro-optical material between said layer and the carrier surface.

Such an electronic device can be formed by executing the steps of the first method of the present invention. It is emphasized that the aforementioned various advantageous embodiments of said method could be used to produce analogous advantageous embodiments of the electronic device of the present invention.

An additional advantage is obtained if the electronic device comprises a flexible carrier. A well-known problem with having a substantially continuous layer of electro-optical elements on a surface of a flexible carrier, e.g., a layer of LC pixels as disclosed in EP 1065553 A1, is that upon bending the surface, the stress on the inner and outer surfaces of the electronic can cause damage to those surfaces, thus damaging the LC pixels of the electronic device. The electronic device of the present invention suffers less, if at all, from this problem, especially when the plurality of discrete electro-optical elements is not covered by an additional layer. Because the electro-optical elements are separated from each other, the outer surface does not experience tensile loading forces when the substrate is bent, thus providing an improved flexible electronic device.

According to a further aspect of the invention, there is provided an apparatus for producing an electronic device comprising a plurality of electro-optical elements on a surface of a carrier, the apparatus comprising receiving means for receiving the carrier and depositing means for depositing a plurality of discrete droplets of a liquid on the carrier surface, the liquid comprising a mixture of an electro-optical material and a polymer precursor, the depositing means being arranged opposite the receiving means, with at least one of the receiving means and the depositing means comprising mechanical translation means for changing an orientation of the depositing means over a first part of the carrier surface to an orientation over a second part of the carrier surface. Such an apparatus is capable of depositing the droplets of a first liquid on the carrier surface in accordance with the method of the present invention.

In an embodiment, the apparatus further comprises means for forming the plurality of electro-optical elements by exposing the plurality of discrete droplets to a stimulus for polymerizing the polymer precursor of a discrete droplet of the liquid into a discrete polymer layer enclosing the electro-optical material of the discrete droplet between said polymer layer and the carrier surface. The additional means ensure that the apparatus is also capable of implementing the step of forming the polymer layers in accordance with the method of the present invention.

Advantageously, the depositing means comprise a printing head having a plurality of nozzles. This increases the efficiency of the implementation of the method of the present invention, because a larger number of droplets can be deposited at the same time.

It is a further advantage if a first subset of the plurality of nozzles is coupled to a reservoir for containing a first liquid comprising a mixture of a first electro-optical material and a first polymer precursor and a second subset of the plurality of nozzles is coupled to a reservoir for containing a second liquid comprising a mixture of a second electro-optical material and a second polymer precursor. This way, droplets having different compositions can be deposited at the same time, which is particularly advantageous for the production of colour display devices via the method of the present invention.

The invention is described in more detail and by way of non-limiting examples with reference to the accompanying drawings, wherein:

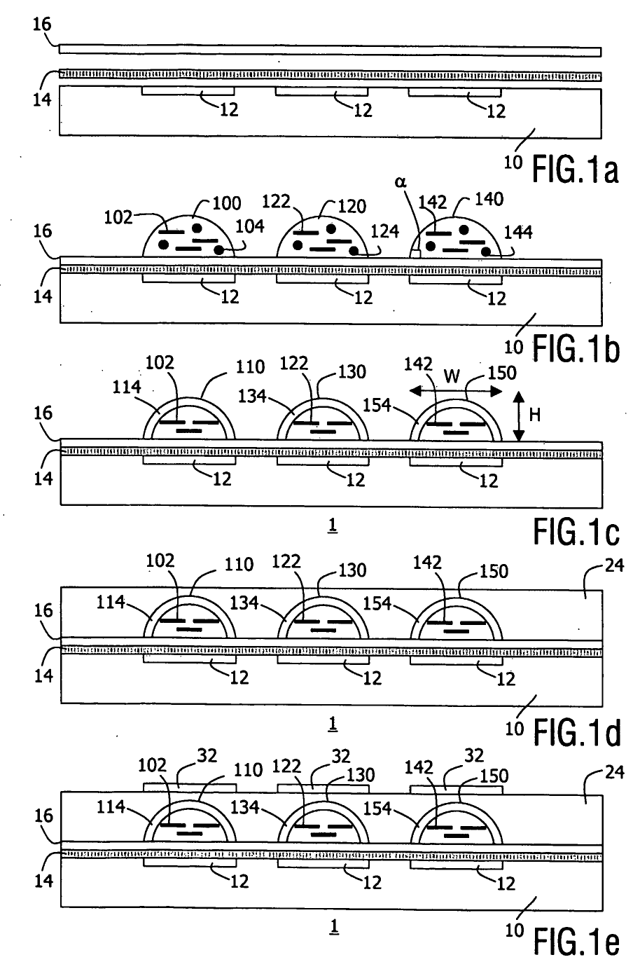

FIGS. 1-3 schematically depict various embodiments of the first method and electronic device of the present invention;

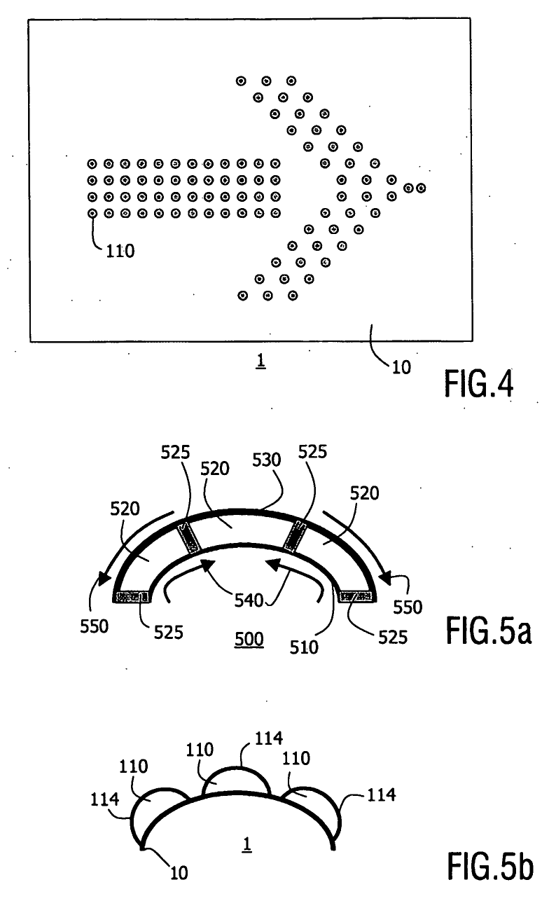

FIG. 4 schematically depicts another embodiment of the electronic device of the present invention;

FIG. 5 schematically depicts a prior art display device and a display device of the present invention having bent carriers;

FIG. 6 schematically depicts an apparatus for implementing the first or the second method of the present invention; and

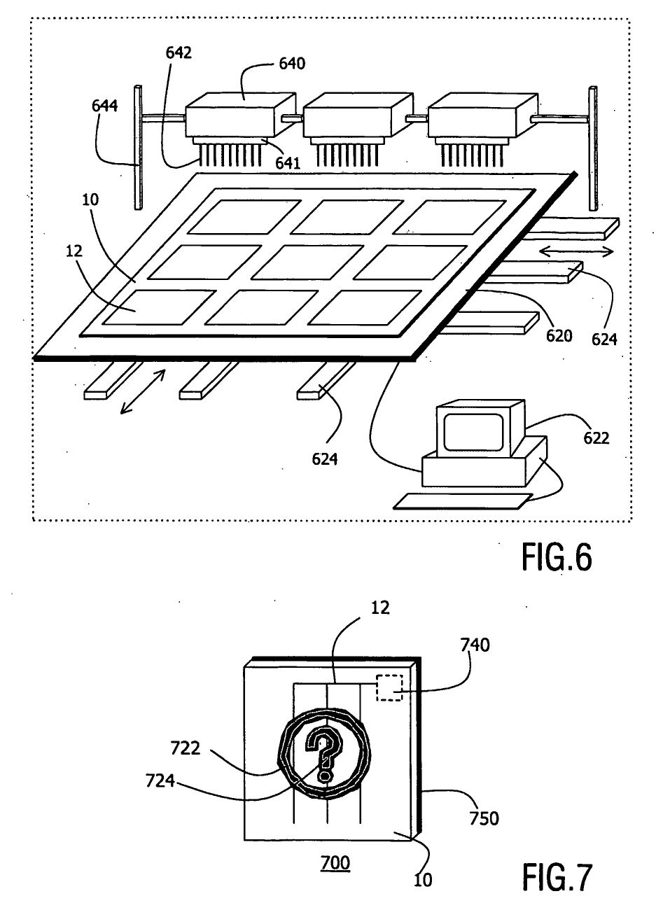

FIG. 7 depicts an electronic device formed by the second method of the present invention.

It should be understood that the Figures are merely schematic and are not drawn to scale. It should also be understood that the same reference numerals are used throughout the Figures to indicate the same or similar parts.

FIG. 1a shows a carrier 10 including an optional electrode structure 12. It is emphasized that FIG. 1 and the following Figs. show an embedded electrode structure 12 for reasons of clarity only. It should be understood that the surface of the carrier 10 preferably may also be defined by placement of the electrode structure 12 on top of the carrier 10. The electrode structure 12 can be formed on top of the carrier 10 from known materials, e.g., Indium Tin Oxide (ITO), and by known techniques for forming electrode structures on a carrier 10. The carrier 10 may comprise any suitable material, e.g., glass, polymer, or even non-obvious materials as modified wood, ceramics or modified paper. Optionally, the surface of carrier 10 that carries the optional electrode structure 12 may also be further modified prior to the formation of the electro-optical elements on the surface. For instance, if the electro-optical elements are light valves utilizing light polarization effects, e.g., liquid crystal elements, a light-polarizing layer 14 may be deposited on the surface of carrier 10 prior to the formation of the electro-optical elements on the carrier surface. The light-polarizing layer 14 may be formed from known light-polarizing materials. Alternatively, a light-polarizing layer may be placed on a further surface of the carrier 10 substantially in parallel with the surface including the electrode structure 12. In addition, an optional orientation layer 16 may be deposited on the surface of carrier 10. The orientation layer 16 may be formed from known materials such as polyimides, which may be a rubbed polyimide such as Al3046, which is supplied by the JSR electronics company of Japan to achieve a desired orientation direction of an electro-optical material like a liquid crystal material. Alternatively, photo-aligning materials such as cinnamates and coumarin may be used, which induce orientation in an electro-optical material like a liquid crystal material after being exposed to linearly polarized light.

In a next step, the precursors for a plurality of electro-optical elements are deposited on the surface of carrier 10. The result of this depositing step is shown in FIG. 1b, where a plurality of discrete droplets 100, 120 and 140 have been deposited on the carrier surface. The deposition can be achieved by means of known printing techniques such as piezo-electric inkjet printing, continuous printing and bubble jet printing. The droplets may have been deposited as single droplets or as a deposition of a plurality of droplets in one location in order to achieve a large droplet comprising a plurality of smaller droplets. The printer used for the deposition of the droplets 100, 120 and 140 may be a multi-nozzle printer, in which case the droplets 100, 120 and 140 may be printed at the same time in a parallel printing step, which makes the production process of the electronic device more efficient.

The droplets 100, 120 and 140 may all be of a first liquid, the first liquid comprising a mixture of a first electro-optical material 102, 122, 142 and a first polymer precursor 104, 124, 144, in which case the plurality of electro-optical elements to be formed from droplets 100, 120, 140 are all of the same type. A polymerization initiator may also be present in the liquid to start a polymerization reaction upon subjecting the droplets to an appropriate stimulus. As emphasized before, the droplets 100, 120 and 140 can be printed onto the carrier 10 using known printing techniques.

The individual deposition of the droplets has the large advantage that the liquids from which droplets 100, 120 and 140 are formed can be chosen to differ from each other in that at least the electro-optical materials 102, 122 and 142 are different in each liquid. Optionally, the polymer precursors 104, 124, 144 as well as the polymerization initiators may also be different. When the electro-optical materials 102, 122 and 142 are different in each liquid, several pluralities of different electro-optical elements may be formed, which for instance may be beneficial if the electro-optical elements are to define RGB pixels of a colour display device, in which case different electro-optical materials 102, 122 and 142 can be chosen to generate RGB pixels including an electro-optical material that is particularly suited for that pixel type. Alternatively, an RGB full colour display device may be conveniently realized using in respective first, second and third elements, respective red, green and blue colorants which selectively accumulate in the respective polymer layers of the first, second and third elements. Thus the number of steps required to make such a device are reduced and the process of providing the colorants is self-aligned with the liquid.

The printing of several pluralities of droplets can for instance be achieved by using the various nozzles of a multi-nozzle printer to print droplets having such differing compositions, e.g., a first nozzle being arranged to print a first liquid comprising a mixture of a first electro-optical material and a first polymer precursor and a second nozzle being arranged to print a second liquid comprising a mixture of a second electro-optical material and a second polymer precursor. Another option to further optimize the production process is to use a different multi-nozzle head for the deposition of each of the various liquids.

In a next step, the droplets 100, 120 and 140 are exposed to a stimulus for initiating a polymerization reaction of the polymer precursor 104, 124 and 144 to transform the droplets 100, 120 and 140 into electro-optical elements 110, 130 and 150. Such a stimulus may for instance be exposure to UV light or heat if the polymerization reaction to be induced in the respective droplets 100, 120 and 140 is of a photo-induced or thermally induced type, respectively. Obviously, a suitable polymerization initiator has to be chosen accordingly. Polymerization can also be directly induced by an electron beam.

Upon exposure of the droplets to the stimulus, the photo-initiated polymerization reaction takes place at the surface of the droplets 100, 120 and 140 and triggers a phase-separation within these droplets. Consequently, the respective electro-optical materials 102, 122 and 142 are enclosed between the surface of the carrier 10 and the respectively formed discrete polymer layers 114, 134 and 154.

A non-limiting example of a suitable composition of a first liquid to be deposited in droplet form as electro-optical element precursors on a carrier is as follows:

50 weight percent (wt %) of a liquid crystal mixture, for instance the mixture E7, which is marketed by Merck, the liquid crystal mixture being an embodiment of the electro-optical material 112;

44.5 wt % photo-polymerizable isobornylmethacrylate (supplied by Sartomer) and 4.5 wt % of a stilbene dimethacrylate dye

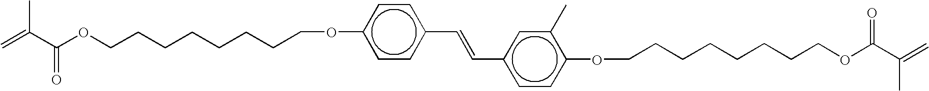

, the synthesis of which has been disclosed in PCT patent application WO 02/42382 and which is hereby incorporated by reference, the two acrylates being an embodiment of the polymer precursor 114; and

0.5 wt % benzildimethylketal, which is marketed by Ciba-Geigy under the trade name Irgacure 651.

Optionally, a colorant which selective accumulates in the polymer layer upon photo-polymerization may be included. The colorant may for example be an azo dye functionalized with a reactive group such as a (meth)acrylate group such as the dye 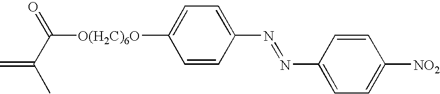
This dye has an absorption peak around 400 nm.

A non-limiting example of the printing process of the present invention using the embodiment of the first liquid given above is as follows. In a test setup, a 6×6 inch square glass carrier 10 was provided with an interdigitated electrode structure 12 and a rubbed polyimide orientation layer Al3046 from the JSR electronics Company of Japan. The dimensions were chosen to fit 9 small displays on the carrier 10. It is emphasized that much larger dimensions for the carrier 10 are equally feasible, however. The carrier 10 was mounted on a computer controlled X-Y table having a variable speed of 1-30 mm/s.

A MicroDrop inkjet printing device was placed in a fixed position over the X-Y table. The dispensing head of the MicroDrop inkjet printing device included a glass capillary shaped into a nozzle on one side, the capillary being surrounded by a tubular piezo-activator for generating a pressure wave through the capillary. The pressure wave triggers the release of a droplet of the first liquid from the capillary. The shape of the pressure wave as well as the diameter of the capillary nozzle can be varied to control the size of the droplets to be released. Here, a pressure wave having a single block shape and a 70 micron nozzle have been used, leading to droplet diameters of 60-75 micron at the nozzle exit, each droplet having having a volume of around 70 picoliter. Each of the droplets 100, 120 and 140 were formed on the carrier 10 by depositing 75 droplets over a single part of the electrode structure 12.

The droplets 100, 120 and 140 were exposed to UV light from a Philips TL08 UV lamp with a light intensity of 0.1 mW/cm² for 30 minutes at 40° C., after which the formation of the electro-optical elements 110, 130 and 150 was completed.

The inclusion of a compound having a chromophore strongly absorbing in the UV region of the electromagnetic spectrum, i.e., the stilbene dimethacrylate dye in the example above, causes a gradient in the UV intensity through the droplets 100, 120 and 140. This effect may be amplified by the UV absorptions of the other components of the liquids used to form these droplets, like the other components of the polymer precursors 104, 124 and 144 and the electro-optical materials 102, 122 and 142. Consequently, the polymerization reaction predominantly takes place at the surface of the droplets 100, 120 and 140 facing the UV source. When other stimuli for triggering the polymerization reaction are used, care has to be taken that the polymerization reaction predominantly takes place at the surface of the droplets 100, 120 and 140.

At this point, it is emphasized that the viscosity of the liquid has a marked influence on the printing process. For instance, the operational ink viscosity range of suitable piezoelectric inkjet printers ranges from approximately 1-20 mPa·s. It should be understood that other ranges may be appropriate for different types of printing devices. If the liquid has a higher viscosity, heating of the nozzles of the printer is preferred to lower the viscosity. Apart from heating, the viscosity of the liquids used in the printing process from which the droplets 100, 120 and 140 are formed may also be controlled in a number of alternative ways.

A first option is to add an inert solvent to the liquid to lower its viscosity, like anisole or xylene. However, care has to be taken that the solvent is not too volatile, because this may lead to the solvent evaporating from the liquid before it has left the nozzle of the printer. This can lead to blockage of the printer nozzle, since this nozzle may be no more than a few tens of microns wide. Also, the evaporation speed of the solvent should not be too low, since this will slow down the process of the solvent evaporating from the droplets 100, 120 and 140, which has a negative impact on the production speed of the electronic devices of the present invention. It has been found that solvents having a vapour pressure in the range from 0.04 kPa to 4 kPa at 298 K are most suitable for such an application. Care also has to be taken that the fraction of solvent remaining in the droplets 100, 120 and 140 is low enough before initiating the polymerization of the polymer precursors, because the solvent otherwise may interfere with the phase separation or with the correct functioning of the electro-optical material.

Alternatively, the various components that make up the liquids can be chosen to modify the viscosity of the liquid. For instance, the liquid crystal mixture E7 may be replaced by a lower viscosity liquid crystal material like the single component cyanobiphenyl liquid crystal marketed by Merck under the name K15 to lower the viscosity of the liquid given in the aforementioned example.

Also, a low viscous and volatile reactive monomer may be used to tune the viscosity of the liquids used as printing inks. Prior to the polymerization of the polymer precursors 104, 124 and 144, most of the volatile reactive monomer will already have evaporated and the remaining fraction will be incorporated in the polymer layers 114, 134 and 154, thus causing no interference with the electro-optical properties of the electro-optical materials 102, 122 and 142.

It is pointed out that in the case of multi-component electro-optical materials, the polymerization process may alter the composition of the electro-optical materials 102, 122 and 142, because some of the various components of the electro-optical materials may be partially enclosed in the respective polymer layers 114, 134 and 154. This can be an unwanted phenomenon if the electro-optical properties of the electro-optical elements 110, 130 and 150 are affected as a consequence.

This can be avoided by formation of a small number of electro-optical elements on a small test carrier, with subsequent evaluation of the composition of the electro-optical materials in those electro-optical elements by for instance high performance liquid chromatography (HPLC). If the concentration of a component of the electro-optical material is discovered to be lower than intended, the fraction of this component in the first liquid can be increased and the test formation of the electro-optical elements can be repeated until the electro-optical materials in the electro-optical elements have the desired composition.

FIG. 1c schematically depicts the formed electro-optical elements 110, 130 and 150, which have been formed from respective droplets 100, 120 and 140. The electro-optical elements 110, 130 and 150, which may operate as pixels of a display device, have respective polymer layers 114, 134 and 154, which respectively have been formed from polymer precursors 104, 124 and 144, and which respectively enclose the electro-optical materials 102, 122 and 142 between their inner surfaces and the surface of carrier 10. This way, a plurality of electro-optical elements is formed that each have a discrete polymer layer with a substantially uniform thickness from the first contact point with the surface of the carrier 10 to the second contact point with the surface of the carrier 10. The electronic device 1 shown in FIG. 1c may be the end product, in which case the electrode structure 12 may be an electrode structure suitable for controlling the electro-optical materials 102, 122 and 142 from a single side using in-plane switching. This can for instance be achieved using an interdigitated electrode structure.

At this stage, it is pointed out that the use of the wording ‘discrete’ to define a property of the droplets 100, 120 and 140 or a property of the polymer layers 114, 134 and 154, should not be interpreted to mean that the droplets 100, 120 and 140 or the polymer layers 114, 134 and 154 have to be completely separated from each other. Minor contact areas between the droplets 100, 120 and 140 or the polymer layers 114, 134 and 154 may exist near the surface of the carrier 10 without departing from the scope of the present invention. It will be understood that the size of such contact areas between two neighbouring droplets will have to remain small enough to prevent neighbouring droplets from merging.

In FIG. 1d, an optional further processing step on the electronic device shown in FIG. 1c is depicted. In this step, a planarization layer 24 is deposited on top of the plurality of electro-optical elements 110, 130 and 150. The planarization layer 24, which may be formed from any known suitable planarization material, facilitates the deposition of further layers such as a polarizing layer (not shown) or the deposition of a further electrode structure 32 on the plurality of electro-optical elements 110, 130 and 150 opposite to the electrode structure 12, as shown in FIG. 1e. If, however, the electro-optical elements 110, 130 and 150 are flat enough, the planarization layer 24 may be omitted and the further electrode structure 32 may also be deposited directly on top of the polymer walls 114, 134 and 154 of the respective electro-optical elements 110, 130 and 150.

The further electrode structure 32 and the electrode structure 12 may form the rows and columns of the electronic device 1. Alternatively, the further electrode structure 32 may be an interdigitated electrode structure to facilitate in-plane switching of the electro-optical elements, in which case electrode structure 12 may be omitted. The further electrode structure 32 may be formed from the polymer semiconductor material polyethylenethioxythiophene (PEDOT) or similar materials that have the advantage that they can be processed at a temperature low enough to avoid damage to the electro-optical elements 110, 130 and 150.

Alternatively, the layer 24 may be formed of a light reflecting coating in the case of the electro-optical materials 112, 132 and 152 comprising reflective TN, STN, ECB and IPS LC materials, to form a reflective display device. It should be obvious to those skilled in the art that, where possible, the aforementioned processing steps may be combined or interchanged without departing from the teachings of the present invention.

At this point, it is emphasized that the droplets 100, 120 and 140 in FIG. 1b and the electro-optical elements 110, 130 and 150 in FIG. 1c have been represented having a hemispherical shape by way of non-limiting example only. A hemi-spherical shape may be preferable in application domains where the electro-optical elements need to have lens-like characteristics, in which case the width W of the formed electro-optical element is of a similar magnitude as height H. In contrast, in application domains where the electro-optical elements have to operate as light valves, e.g., LCDs and electrophoretic displays like E-ink displays, it may be preferable to have droplets with flattened surfaces in order to avoid unwanted optical effects, in which case width W can be much larger than height H. For example, W may be 1,000 micron or more, whereas H may typically be a few tenths of microns.

The shape adopted by the electro-optical elements 110, 130 and 150 can be controlled by modifying the contact angle α of the droplets 100, 120 and 140 with the surface of the carrier 10. A low contact angle α, i.e. a good wetting, facilitates the formation of a thin electro-optical element having a relatively flat surface, especially if the element is formed from a large droplet formed by depositing a plurality of smaller droplets in the same location at the surface of the carrier 10. In case of an LCD, electro-optical elements 110, 130 and 150, having a relatively flat surface can be especially advantageous when the electronic device 1 is a display device, because the light passing through such electro-optical elements at most experiences minor distortion, thus yielding a display device having a good image quality. When the contact angle α of the discrete droplets 100, 120 and 140 with the carrier 10 is low, care has to be taken that the discrete droplets 100, 120 and 140 do not merge with neighbouring discrete droplets. Also, height H of the droplets should be large enough to enable the proper functioning of the electro-optical materials 102, 122 and 142 in the corresponding electro-optical elements 110, 130 and 150. This is particularly relevant if the electro-optical materials 102, 122 and 142 are LC materials, in which case the height H of the electro-optical elements 110, 130 and 150 should be substantially constant throughout the full width W of the electro-optical elements 110, 130 and 150 to ensure a proper LC effect in the electro-optical elements 110, 130 and 150. Furthermore, prevention of excessive spreading of the droplets 100, 120 and 140 will improve the resolution of the electronic device to be produced.

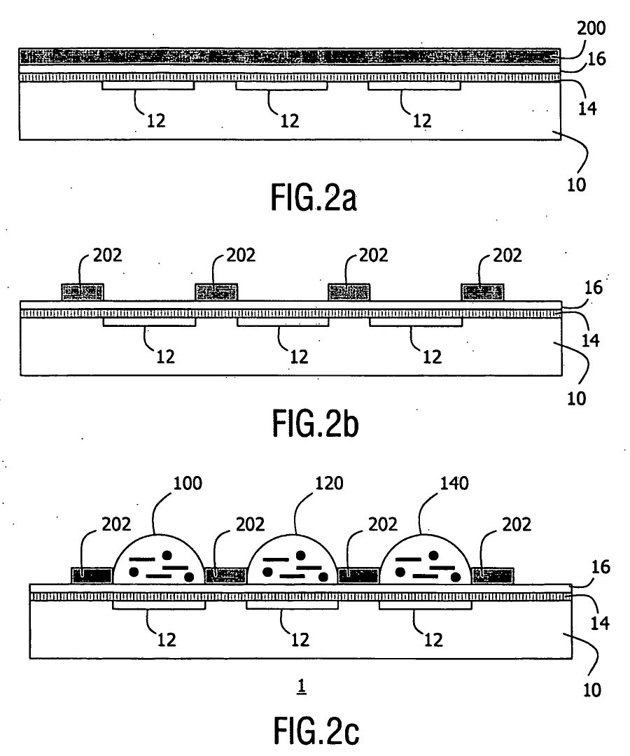

To enable the droplets 100, 120 and 140 to be printed on the surface of the carrier 10 assuming the desired form, the surface of carrier 10 may be modified prior to the deposition of the droplets 100, 120 and 140. In FIG. 2, an example of such a modification is shown. FIG. 2a shows the carrier 10 with an electrode structure 12, an optional polarization layer 14 and an optional orientation layer 16 on its surface, on which a photosensitive lacquer 200 is deposited. The photosensitive lacquer 200 is patterned in a photolithography step to form a pattern of wall structures 202 on the surface of the carrier 10, as shown in FIG. 2b. The pattern of wall structures 202 forms a relief pattern on the surface of the carrier 10. Alternatively, such a relief pattern can for instance also be obtained through photo-embossing, injection moulding, screenprinting, microcontact printing or two-step photo-polymerization techniques.

Next, the droplets 100, 120 and 140 are deposited in separate cavities between the wall structures 202 formed on the modified carrier 10, leading to an intermediate electronic device as shown in FIG. 2c. The deposition of the droplets 100, 120 and 140 into a bordered area has the advantage that spreading of the droplets is prevented and that the area can be filled up, thus providing droplets 100, 120 and 140 having a sufficient height H. At this point, it is emphasized that the shape of the wall structures 202 is not limited to the shape shown in this example. For instance, tapered walls or a multitude of stacked polymer layers forming the walls may also be used without departing from the scope of the present invention.

Furthermore, it will be understood that the modification steps of the surface of the carrier 10, e.g., the deposition of the optional orientation layer 16, may also take place after the development of the wall structures 202.

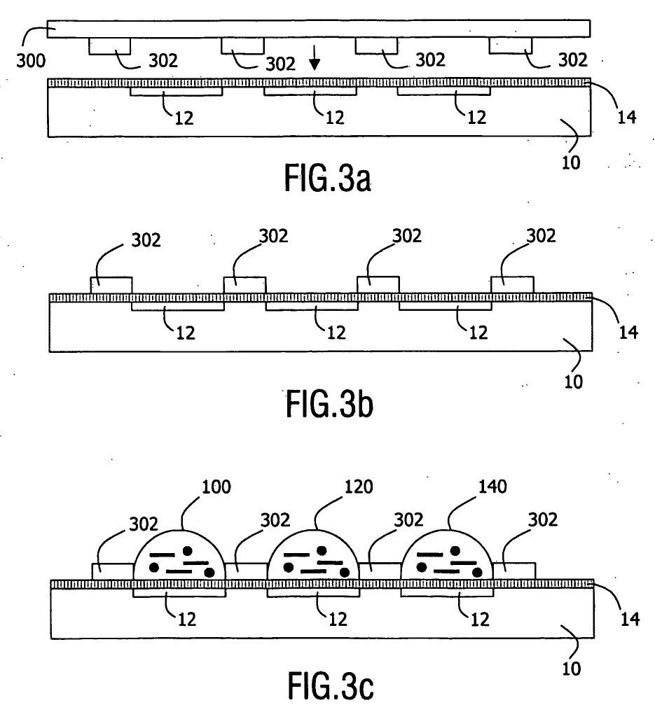

An alternative carrier modification method to achieve these advantages is shown in FIG. 3. In FIG. 3a, a stamp 300 such as a polydimethylsiloxane (PDMS) stamp is used to print regions 302 of a nonwetting material on the surface of the carrier 10. If required, the regions 302 may be offset printed on top of an optional orientation layer 16, such as the aforementioned Al3046. As an ink for the PDMS stamp 300, a homeotropic alignment material such as SE7511 from the Nissan Chemical Company from Japan may be used, although the use of other known offset printing inks, e.g., polyimides, is also possible.

The printing of the regions 302, which may be done with a stamp simultaneously contacting the whole surface of the carrier 10 or with a stamp that is rolled over the surface of the carrier 10, provides a plurality of bordered domains on the carrier surface, as shown in FIG. 3b. The nonwetting regions 302 ensure that the wetting on the surface carrier 10 predominantly takes place in the bordered domains upon deposition of the droplets 100, 120 and 140, thus yielding an intermediate structure of the electronic device as shown in FIG. 3c. Good nonwetting properties of the carrier surface can be achieved by choosing a nonwetting material, e.g., the aforementioned SE7511, which causes the contact angle E of the droplets 100, 120 and 140 with the carrier 10 to be at least 10 degrees larger at the regions 302 compared to the contact angle □ with the untreated regions of the carrier 10.

Rather than using offset printing, the regions 302 of a dewetting material may be also be deposited by alternative printing techniques such as microcontact printing, flexo-graphic printing, screen printing, inkjet printing, gravure printing, gravure-offset printing or tampon printing.

Optionally, before depositing the plurality of discrete droplets, the substrate carrier surface is provided with a plurality of first regions functionalized for selective accumulation of polymer material and a plurality of second regions functionalized for selective accumulation of the electro-optical material (102), respective first regions being provided between respective second regions and respective regions (302) of a non-wetting material. Having such regions facilitates phase separation in the desired manner and improves mechanical stability of the structure obtained after phase separation because the first region generally improve adhesion between the carrier surface and the polymer layer. The first and second regions may be regions of high and low affinity, respectively, for precursor polymer. Mechanical stability is particularly improved if the high affinity regions are functionalized with chemically reactive groups and the regions of low affinity are not so functionalized, the chemically reactive groups being adapted to react with the polymer precursor. Alternatively or in addition, the first and second regions can be functionalized for facilitating a high and low rate of polymerization respectively. This can be achieved by means of a low (including zero) and high concentration of polymerization inhibitor in the first and second region respectively.

Material for forming the first and/or second regions are known in the art per se. Example of materials for forming first regions provided with reactive groups and physical bonding of the first region to the underlying carrier surface include polymers or oligomers with reactive side-chains such as (meth)-acrylate side chains, optionally diluted with inert solvent for ink jet printability. An example of such a polymer is a photosensitive polyimide precursor, more particular a polyamic ester containing acrylate side chains dissolved in N-methylpyrrolidone such as Durimide™ available from Arch chemicals, a typical molecular structure of which is shown below.

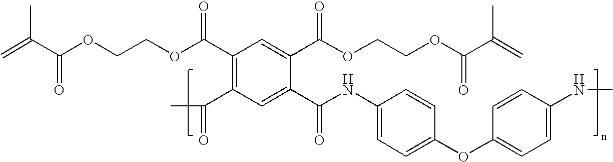

Also suitable, in case of acrylate reactive groups, are polymers or oligomers containing amine groups. Amine groups react with acrylate groups in a Michael's addition reaction. The amine groups can be incorporated into the carrier in a patterned way. But also possible is to print on top of the carrier a pattern of polyimide precursor polymer. This precursor is not or only partly cured after printing such that reactive units remain available.

Multifunctional (meth-)acrylate monomers or a mixture thereof and a photo initiator may also be used. Bisphenol A di(meth)acrylate or tripropyleneglycoldiacrylate are good candidates. After printing, the mixture can be partly polymerized by a UV exposure. This ensures the immobilization of the printed patterns. The groups that have not reacted can be used for chemical bonding to the polymer formed during the stratification process. The mixture needs a sufficient high viscosity, to prevent it from spreading over the carrier surface after printing.

First regions can also be chemically bonded to the carrier surface as well as the polymer layer. This can be achieved for example by means of functionalized (chloro)silanes in combination with a polyvinylalcohol (PVA) carrier surface. Chloro-silanes chemically bond with the hydroxyl groups of the PVA. Since the silanes are micro contact printable, a patterned monolayer of for example (meth)-acrylatechlorosilanes can be printed. The polymer precursor is selected to be capable of reacting with the (meth)acrylate groups of the silane.

Carrier surfaces of cinnamate or coumarine type of photo-alignment materials in combination with thiols can also be used to form first regions having reactive groups.

Obviously, the type of reactive group to use depends on the polymer precursor. For example if the precursor polymer is a thiolene, the material for the first region may be an (meth)acrylate, a vinyl, a thiol groups or an amine compound. Epoxide precursor polymers cured by cationic polymerization can be combined with printed structures containing epoxide, amine, acid, acide anhydride, acid chloride groups.

Further materials which can be suitably used to provide the first and second regions are available in the art as such. For details, reference is made to the European patent application with application number 03102443.3 filed by Applicant and European patent application with application number 03102445.8 filed by Applicant and the applications which claim the priority of each thereof, the content of all of which is incorporated by reference.

The non-wetting and/or first region and/or second region may be provided in any desired pattern to provide the electro-optical elements with a desired outline. A grid or pattern of squares may be used, which for example corresponds to pixel boundaries of a display. Other shapes can be also applied such as a hexagonal shape to make a honeycomb structure, which is known to have outstanding mechanical properties. Circularly shaped structures can also be made. The sizes of the structures can be chosen the same or different from the pixel size. For instance larger where several pixels are enclosed or, oppositely smaller where each pixel contains more than one encapsulated liquid crystal capsule. The thickness of the non-wetting, first and/or second regions can be chosen differently. The thickness can be of the order of 1 nanometer (in the case of a monomolecular silane layer) to several hundreds of nanometers in case of printed polyimide. In such cases, the polymer layer would typically provide the wall of the electro-optical elements. But of course thicker layers can be printed that form a substantial part of the polymer walls or are substantially form the walls of the electro-optical elements.

The first and/or second regions may be provided before or after depositing the non-wetting regions (302). The first regions may partially overlap with the region 302 or provided adjacent thereto (abutting or spaced). Methods suitable for depositing the non-wetting regions may also be used to provide the first and second regions.

A convenient way to apply a non-wetting region on top of a first region formed of the reactive polyimide described above is offset printing a monolayer of an amphiphilic material having at one side a group that is capable reacting with the acrylate group of the reactive polyimide material and at the other side an apolar tail like alkyl groups or fluorinated alkyl groups. Example of such an amphiphilic compound is an alkylthiol (e.g. octadecyl thiol). The thiol reacts with the acrylate double bond of the reactive polyimide under the action of heat or UV light in the presence of a free radical initiator, such as an alkylamine (e.g. octylamine).

As opposed to having separate nono-wetting and first regions, the non-wetting region may be provided with reactive groups capable of reacting with the precursor polymer thus saving one patterned deposition step. A homeotropic polyimide alignement material functionalized with (meth)acrylate groups may be used for this purpose.

In FIG. 4, an advantageous embodiment of an electronic device 1 according to the present invention is depicted. A predefined part of the surface of carrier 10 of the electronic device 1 carries a plurality of electro-optical elements 110 arranged in a corresponding predefined pattern. It will be appreciated by those skilled in the art that with the production method of the present invention, such an electronic device 1 can be easily produced, because the whole surface of the carrier 10 can be equipped with a regular electrode structure (not shown), with the predefined pattern of the electronic device being built-up by means of a plurality of discrete electro-optical elements 110, or, several pluralities of electro-optical elements, e.g., electro-optical elements 110, 130 and 150 as previously shown. Rather than having to shape an electrode structure in a predefined pattern and cover the whole surface of the carrier 10 with electro-optical elements, which is a time-consuming and costly process typically associated with segmented display devices, the method of the present invention allows for a more facile way of producing such an electronic device, because the electro-optical elements 110 can be produced individually on top of the regular electrode structure, thus yielding a more simple and cheaper electronic device 1 that can be produced faster.

The fact that the electro-optical elements 110 are individually formed on the surface of carrier 10 also facilitates the formation of electronic devices 1 and in particular display devices having a non-rectangular shape, because the formation of the electro-optical elements 110 is no longer related to the shape of carrier 10. In fact, the shape of the carrier 10 may be any shape that allows the formation of a functioning electrode structure on its surface.

The electronic device 1 of the present invention also has particular advantages when the carrier 10 is a flexible carrier. FIG. 5a schematically depicts an electronic device 500 in a bent state. The electronic device 500, which can be produced using prior art production methods, such as for instance disclosed in PCT patent application WO 99/21052, has a plurality of electro-optical elements 520, which are typically separated by polymer walls or lithographic spacers 525 and which are sandwiched between a flexible carrier 510, which may be formed from a thin polymer such as a modified polycarbonate foil marketed by the Tejin company, and a polymer layer 530, which is sealed to the flexible carrier 510. Due to the presence of the top layer 530, the carrier 510 experiences an inward directed stress force in the bent state as indicated by arrows 540, whereas the top layer 530 experiences an outward directed stress force indicated by arrows 550. This causes a stress load on the electronic device 500 that may lead to the failure of the device. Also, the electro-optical elements 510 can deform under such stress loads, which in particular in the case of the electro-optical material in these elements being an LC material causes deterioration of the display qualities such as variations in the grey scales of the various electro-optical elements 510 of the electronic device 500.

In comparison, FIG. 5b shows an electronic device 1 according to the present invention. The electronic device 1 has a flexible carrier 10, which may be formed from the same polymer substrate as that of electronic device 500 or another suitable flexible material, the carrier 10 carrying a plurality of discrete electro-optical elements 110 on its surface. Because the electro-optical elements 110 of the electronic device 1 of the present invention are not formed by a continuous layer such as a polymer layer 530 but are formed by separate discrete polymer layers 114 instead, the electronic device 1 is not subjected to a stress load upon bending of the carrier 10. Consequently, the performance of the electronic device 1 in general and of the electro-optical elements 110 in particular is not compromised when the electronic device is bent.

A further advantage of applying the present invention to flexible substrates is that the electro-optical elements of the present invention typically only have a height H as shown in FIG. 1c of a few tenths of microns, thus having a positive effect on the reduction of the overall thickness of the flexible electronic device. This is of particular relevance to matrix array electronic devices based on organic semiconductor materials, because the electro-optical printing technique of the present invention can be performed at temperatures that are low enough to ensure that the organic semiconductor materials are kept intact. In addition, such an electronic device 1 can be kept thin enough to be rolled up, without causing excessive stress to the various layers of the electronic device in its rolled-up state.

FIG. 6 shows an embodiment of an apparatus 600 for producing an electronic device 1 comprising a plurality of electro-optical elements on a surface of a carrier 10 by implementing the method of the present invention. An XY-table 620 is arranged to receive the carrier 10, which in this case carries an electrode structure 12. In the example shown in FIG. 6, 9 electrode structures 12 corresponding with 9 electronic devices to be produced are depicted as a non-limiting example only. The XY table 620 can be translated over tracks 624 under control of computer system 622.

Opposite the surface of the XY table 620 that carries the substrate 10, the apparatus 600 preferably includes a plurality of printing devices 640 in a fixed construction 644, although a single printing device 640 is also feasible. The printing devices 640 are arranged to deposit a plurality of discrete droplets of a liquid on the carrier surface. To this end, each of the printing devices 640 preferably includes a printing head 641 having a plurality of nozzles 642 with their outlets pointed towards the XY table 620, although single-nozzle printing heads 641 are also feasible. All of the nozzles 642 may be attached to a single reservoir (not shown) for containing a first liquid comprising a mixture of a first electro-optical material 102 and a first polymer precursor 104, in which case all the electro-optical elements to be formed will contain the same electro-optical material.

Alternatively, a subset of the nozzles 142 may be attached to a reservoir (not shown) for containing a first liquid comprising a mixture of a first electro-optical material 102 and a first polymer precursor 104, while another subset of the nozzles 142 may be attached to a reservoir for containing a second liquid comprising a mixture of a second electro-optical material 122 and a second polymer precursor 124, in which case different types of electro-optical elements can be deposited in parallel. Also, the printing devices 640 may comprise a plurality of printing heads 641 to further optimize the printing process of the present invention. The printing devices 640 may be known printing devices such as piezo-electric or continuous inkjet printing devices or bubble jet printing devices.

Preferably, the apparatus 600 also comprises means for forming the plurality of electro-optical elements such as an UV-lamp (not shown) or a heat source (not shown).

It will be understood by the skilled person that instead of having a translation table 620, fixed means 620, e.g., a fixed table, for receiving the carrier 10 and a plurality of printing devices 640 in a XY translation construction 644 can also be used without departing from the scope of the present invention. Furthermore, it will be obvious that the apparatus 600 can also be used to deposit the first liquid in accordance with the second method of the present invention by allowing the merging of the deposited droplets.

FIG. 7 depicts an electronic device 700 obtained with the second method of the present invention. The electronic device 700 has a carrier 10 with an electrode structure 12, e.g., an interdigitated electrode structure, on its surface. Parts 722 and 724 of the surface of the carrier 10 are covered with an electro-optical material encapsulated between a polymer layer (not shown) and the carrier surface. The parts 722 and 724, which form the display area of the electronic device 700, has been formed by dripping a plurality of droplets of a first liquid comprising a first electro-optical material 102 and a first polymer precursor 104 on the respective parts, after which the display area has been formed by exposing the first liquid to an appropriate stimulus in analogy with the first method of the present invention. To further improve the definition of the parts 722 and 724, a border of a dewetting material (not shown) may have been deposited around the parts 722 and 724. It is emphasized that an unlimited range of different shapes can be defined for the display area with the second method of the present invention, including areas which almost completely cover the surface of the carrier 10.

The electrode structure 12 is conductively coupled to control circuitry 740, which may be as simple as an on/off signal generator. The control circuitry 740 may be responsive to an on/off switch (not shown). The power to be supplied to the electrode structure 12 may be provide by an integrated power supply (not shown) such as a battery, or by an external power source via a conductive contact (not shown) at a further surface of the carrier 10. The further surface may be extended with an adhesive layer 750 to allow the electronic device 700 to be used as a display sticker or as a display laminate. Such a display laminate may be combined with modular toys, e.g., LEGO, with a toy module comprising a matching conductive contact to connect a conductive contact of the electronic device 700 to a power supply. This for instance enables the use of a toy module as a separate ‘pixel’ in a modular display device, for instance by adhering electronic devices 700 with different colour appearances to different toy modules.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of producing an electronic device comprising a plurality of electro-optical elements on a surface of a carrier the method comprising the steps of:
depositing a plurality of discrete droplets of a first liquid on the carrier surface, the first liquid comprising a mixture of a first electro-optical material (102) and a first polymer precursor and
forming the plurality of electro-optical elements by exposing the plurality of discrete droplets to a stimulus for polymerizing the polymer precursor of a discrete droplet of the first liquid into a discrete polymer layer enclosing the first electro-optical material of the discrete droplet between said polymer layer and the carrier surface.

2. A method as claimed in claim 1, wherein a discrete droplet of the first liquid is formed by depositing a plurality of smaller droplets of the first liquid over a same respective part of the electrode structure.

3. A method as claimed in claim 1, wherein the step of depositing a plurality of discrete droplets is preceded by modifying the carrier surface by depositing an electrode structure on the carrier surface.

4. A method as claimed in claim 1, wherein the step of depositing a plurality of discrete droplets is preceded by modifying the carrier surface by depositing an orientation layer on the carrier surface.

5. A method as claimed in claim 1, wherein the step of depositing the plurality of discrete droplets is preceded by the step of depositing a pattern of wall structures on the carrier surface for creating a plurality of bordered domains on the carrier surface, a droplet from the plurality of discrete droplets being deposited in such a bordered domain.

6. A method as claimed in claim 1, wherein the step of depositing a plurality of discrete droplets is preceded by the step of depositing a plurality of regions of a nonwetting material on the carrier surface.

7. A method as claimed in claim 6, wherein, before depositing the plurality of discrete droplets, the substrate carrier surface is provided with a plurality of first regions functionalized for selective accumulation of polymer material and a plurality of second regions functionalized for selective accumulation of the electro-optical material respective first regions being provided between respective second regions and respective regions of a non-wetting material.

8. A method as claimed in claim 1, wherein the first electro-optical material comprises a liquid crystal material.

9. A method as claimed in claim 1, wherein the first liquid comprises a first colorant which, during formation of the plurality of electro-optical elements, selectively accumulates in the polymer layer.

10. A method as claimed in claim 9, wherein the first colorant is functionalized with reactive groups adapted to react with the first polymer precursor during formation of the plurality of electro-optical elements.

11. A method as claimed in claim 10, wherein the first colorant is polymerizable to form a polymer of the discrete polymer layer.

12. A method as claimed in claim 1, further comprising the steps of:
depositing a plurality of discrete droplets of a second liquid on the carrier surface, the second liquid comprising a mixture of a second electro-optical material and a second polymer precursor and
forming a further plurality of electro-optical elements by exposing the plurality of discrete droplets of the second liquid to a second stimulus for polymerizing the second polymer precursor into a further discrete polymer layer enclosing the second electro-optical material between said further polymer layer and the carrier surface.

13. A method as claimed in claim 12, wherein the step of depositing a plurality of discrete droplets of a first liquid on the carrier surface and the step of depositing a plurality of discrete droplets of a second liquid on the carrier surface are executed substantially in parallel.

14. A method as claimed in claim 1, wherein the second electro-optical material comprises a further liquid crystal material.

15. A method as claimed in claim 12, wherein the second liquid comprises a second colorant which, during formation of the plurality of electro-optical elements, selectively accumulates in the further polymer layer and has a color which is different from that of the first colorant.

16. A method as claimed in claim 15, wherein the second colorant is functionalized with reactive groups adapted to react with the second polymer precursor during formation of the plurality of electro-optical elements.

17. A method as claimed in claim 16, wherein the second colorant is polymerizable to form a polymer of the further polymer layer.

18. A method as claimed in claim 1, further comprising the step of depositing a further electrode structure on a polymer layer of the plurality of electro-optical elements.

19. A method as claimed in claim 1, further comprising the step of covering the plurality of electro-optical elements with a light reflecting coating.

20. A method as claimed in claim 1, the method further comprising the step of adding a light-polarizing layer to the carrier the light-polarizing layer being arranged substantially parallel to the carrier surface.

21. A method as claimed in claim 1, further comprising the step of covering the plurality of electro-optical elements with a planarization layer.

22. A method as claimed in claim 1, further comprising the step of providing a further surface of the carrier with an adhesive layer.

23. A method of producing an electronic device comprising a display area on a part of a surface of a carrier carrying an electrode structure the method comprising the steps of:
dripping a first liquid on the part of the carrier surface, the first liquid comprising a mixture of a first electro-optical material and a first polymer precursor and
forming the display area by exposing the first liquid to a stimulus for polymerizing the polymer precursor into a discrete polymer layer enclosing the first electro-optical material between said polymer layer and the carrier surface.

24. A method as claimed in claim 23, further comprising the step of bordering the part of the carrier surface with a dewetting material prior to the dripping of the first liquid on the part of the carrier surface.

25. A method as claimed in claim 23, further comprising the step of providing a further surface of the carrier with an adhesive layer.

26. A method as claimed in claim 25, further comprising the step of integrating a power supply into the carrier.

27. A method as claimed in claim 25, further comprising the step of providing the further surface with a conductive contact, the conductive contact being conductively coupled to the electrode structure.

28. An electronic device comprising:
a carrier having a surface; and
a plurality of electro-optical elements positioned on the carrier surface, each of the electro-optical elements comprising a discrete polymer layer enclosing a first electro-optical material between said polymer layer and the carrier surface.

29. An electronic device as claimed in claim 28, wherein the carrier surface comprises an electrode structure.

30. An electronic device as claimed in claim 28, wherein the carrier surface comprises an orientation layer.

31. An electronic device as claimed in claim 28, wherein the electronic device further comprises a pattern of wall structures for creating a plurality of bordered domains on the carrier surface; an electro-optical element from at least a part of the plurality of electro-optical elements occupying such a bordered domain.

32. An electronic device as claimed in claim 28, wherein the plurality of electro-optical elements are separated from each other by means of nonwetting regions on the carrier surface.

33. An electronic device as claimed in claim 32 wherein the substrate carrier surface is provided with a plurality of first regions functionalized for selective accumulation of polymer material and a plurality of second regions functionalized for selective accumulation of the electro-optical material respective first regions being provided between respective second regions and respective regions of a non-wetting material.

34. An electronic device as claimed in claim 29, wherein the first electro-optical material comprises a liquid crystal material.

35. An electronic device as claimed in claim 29, wherein the discrete polymer layer comprises a first colorant.

36. An electronic device as claimed in claim 35 wherein the first colorant is chemically bonded to a polymer of the discrete polymer layer.

37. An electronic device as claimed in claim 36 wherein the first colorant is polymerized to form a polymer of the discrete polymer layer.

38. An electronic device as claimed in claim 32, the electronic device further comprising a plurality of further electro-optical elements positioned over further respective parts of the electrode structure each of the further electro-optical elements comprising a further discrete polymer layer enclosing a second electro-optical material between said second layer and the carrier surface.

39. An electronic device as claimed in claim 32, wherein the second electro-optical material comprises a further liquid crystal material.

40. An electronic device as claimed in claim 38, wherein the further discrete polymer layer comprises a second colorant having a color different from that of the first colorant.

41. An electronic device as claimed in claim 40 wherein the second colorant is chemically bonded to a polymer of the further discrete polymer layer.

42. An electronic device as claimed in claim 41 wherein the second colorant is polymerized to form a polymer of the further discrete polymer layer.

43. An electronic device as claimed in claim 35, wherein the plurality of electro-optical elements carry a further electrode structure.

44. An electronic device as claimed in claim 35, wherein the plurality of electro-optical elements are covered by a light reflecting coating.

45. An electronic device as claimed in claim 35, wherein the carrier comprises a light-polarizing layer.

46. An electronic device as claimed in claim 35, wherein the plurality of electro-optical elements is covered by a planarization layer.

47. An electronic device as claimed in claim 35, wherein the carrier is flexible.

48. An electronic device as claimed in claim 35, wherein the plurality of electro-optical elements are covering a predefined part of the carrier surface.

49. An electronic device as claimed in claim 35, wherein the electronic device is a display device.

50. An electronic device as claimed in claim 35, wherein a further surface of the carrier carries an adhesive layer.

51. An apparatus for producing an electronic device comprising a plurality of electro-optical elements on a surface of a carrier the apparatus comprising:
receiving means for receiving the carrier and
depositing means for depositing a plurality of discrete droplets of a liquid on the carrier surface the liquid comprising a mixture of an electro-optical material and a polymer precursor the depositing means being arranged opposite the receiving means with at least one of the receiving means and the depositing means comprising mechanical translation means for changing an orientation of the depositing means from over a first part of the carrier surface to an orientation over a second part of the carrier surface.

52. An apparatus as claimed in claim 51, the apparatus further comprising means for forming the plurality of electro-optical elements by exposing the plurality of discrete droplets to a stimulus for polymerizing the polymer precursor of a discrete droplet of the liquid into a discrete polymer layer enclosing the electro-optical material of the discrete droplet between said polymer layer and the carrier surface.

53. An apparatus as claimed in claim 51, wherein the depositing means comprise a printing head having a plurality of nozzles.

54. An apparatus as claimed in claim 53, wherein a first subset of the plurality of nozzles is coupled to a reservoir for containing a first liquid comprising a mixture of a first electro-optical material and a first polymer precursor and a second subset of the plurality of nozzles is coupled to a reservoir for containing a second liquid comprising a mixture of a second electro-optical material and a second polymer precursor.
